(19) United States
(12) Patent Application Publication
(10) Pub. No.: US 2015/0116207 A1
(43) Pub. Date: Apr. 30, 2015

(54) ELECTRONIC DEVICE AND CONTROL METHOD FOR SCREEN THEREOF

(71) Applicant: Pegatron Corporation, Taipei City (TW)

(72) Inventor: Po-Sen CHEN, TAIPEI CITY (TW)

(21) Appl. No.: 14/519,152

(22) Filed: Oct. 21, 2014

(30) Foreign Application Priority Data
Oct. 31, 2013 (TW) 102139566

(51) Int. Cl. G06F 3/01

(52) U.S. Cl. CPC G06F 3/013
USPC 345/156

(57) ABSTRACT

The disclosure invention provides an electronic device, which comprises a screen, an imaging lens, a light sensor and a control unit. The imaging lens is provided for capturing images in front of the screen. The light sensor is provided for sensing an ambient light. The control unit is provided for determining whether human eyes gaze at the screen in the images. When the control unit determines that the human eyes gaze at the screen over a predetermined time, it further adjusts the screen to enter an eye protection mode according to the ambient light, in which the eye protection mode comprises an adjustment of brightness, contrast, color or refresh rate of the screen.

### CROSS-REFERENCE TO RELATED APPLICATIONS

This Non-provisional application claims priority under 35 U.S.C. §119(a) on Patent Application No(s). 102139566 filed in Taiwan, R.O.C. on Oct. 31. 2013, the entire contents of which are hereby incorporated by reference.

### BACKGROUND

1. Technology Field

This disclosure relates to an electronic device and a control method thereof and, more particularly, to an electronic device having an intelligent eye protection function and a control method for screen thereof.

2. Description of the Related Art

The human eye is an organ that reacts to light and has several purposes. As a conscious sense organ, the mammalian eye allows vision. Rod and cone cells in the retina allow conscious light perception and vision including color differentiation and the perception of depth.

With the growth of the technology, more and more people use tablet and smart phone due to their easy and convenient operation. When users operates such the electronic device for to long time, incorrect settings of the screen will injure the human eyes, such as pseudo-myopia, asthenopia and so on.

To solve the abovementioned problems, the relative fields put a lot of effort to find a solution. However, an appropriate method still cannot be developed. Therefore, how to perform an appropriate setting on the screen for protecting the human eyes is one of important issues and is also a purpose to be improved in the relative fields now

### BRIEF SUMMARY OF THE INVENTION

An aspect of the present invention is to provide an electronic device and a control method for screen thereof to solve problems existed in the prior art.

The electronic device provided in the present invention comprises a screen, an imaging lens, a light sensor and a control unit. The imaging lens is provided for capturing images in front of the screen. The light sensor is provided for sensing an ambient light. The control unit is provided for determining whether human eyes gaze at the screen in the images. When the control unit determines that the human eyes gaze at the screen over a predetermined time, it adjusts the screen to enter an eye protection mode according to the ambient light, in which the eye protection mode comprises an adjustment of brightness, contrast, color or refresh rate of the screen.

On the other hand, the control method of the electronic device provided in the present invention comprises the following steps of: (a) capturing images in front of the screen; (b) determining whether human eyes gaze at the screen in the images; (c) sensing an ambient light when the human eyes is determined to gaze at the screen over a predetermined time: (d) adjusting the screen to enter an eye protection mode according to the ambient light, in which the eye protection mode comprises an adjustment of brightness, contrast, color or refresh rate of the screen.

To sum up, the technical solution of the present invention has apparent advantages and beneficial effects in comparison with the prior art. By the abovementioned technical solution, it can achieve quite an improvement, has an extensively industry value in use and at least has advantages as the following:

1. The present invention regards users' health as a starting point to dynamically detect whether human eyes gaze the screen for a long time and to adjust the setting of the screen for achieve a purpose of eye protection; and

2. The present invention does not only adjust the brightness of the screen but also considers the effect of the refresh rate, color and contrast of the screen on the human eyes and adjusts an appropriate refresh rate, color and contrast of the screen so as to protect the human eyes efficiently.

The abovementioned description will be described in the following specification for further explaining the technical solution of the present invention.

### BRIEF DESCRIPTION OF THE DRAWINGS

To allow the abovementioned and other aspects, features, advantages and embodiments of the present invention to be easily understood, the attached figures are described as the following:

FIG. 1 is a block diagram showing an electronic device according to an embodiment of the present invention; and

FIG. 2 is a flowchart showing a method for controlling screen of an electronic device according to another embodiment of the present invention.

### DETAILED DESCRIPTION OF THE INVENTION

Various embodiments of the present invention are further described in the following and cooperated with the attached figures for allowing the description of the present invention to be explicit and complete. The same number will indicate the same or similar elements and steps. Furthermore, the well-known elements and steps do not be described in the embodiments for avoiding the present invention from unnecessary limits.

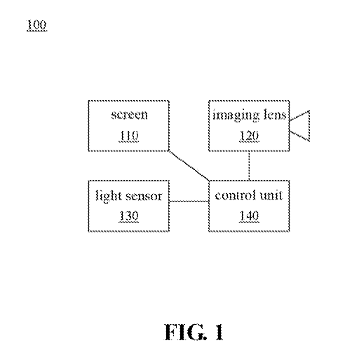

FIG. 1 is a block diagram showing an electronic, device 100 according to an embodiment of the present invention. As shown in FIG. 1, the electronic, device 100 comprises a screen 110, an imaging lens 120, a light sensor 130 and a control unit 140. Structurally, the control unit 140 is coupled with the screen 110, the imaging lens 120 and the light sensor 130.

In particular, the electronic device 100 can be a tablet, a cellular phone, a notebook or other portable electronic devices. The screen 110 can be a liquid crystal screen, an electronic paper and other display devices. The light sensor 130 can be an individual ambient light sensing circuit or integrated the imaging lens 120. The imaging lens 120 can be a built-in front lens and located at the same surface with the screen 110. Alternately, the imaging lens 120 can be an external imaging lens disposed on the screen 110. The control unit 140 can be a central processing unit, a microcontroller or an electronic component having similar functions, and persons having ordinary skill in the art should choose flexibly depending. on the needs at that time.

In use, the screen 110 is provided for displaying a frame, the light sensor 130 is provided for sensing the ambient light, the imaging lens 120 is provided for capturing images in front of the screen 110, and the control. unit 140 is provided for determining whether human eyes gaze the screen 110 in the images captured by the imaging lens 120. If the human eyes gaze at the screen 110, it represents that a user looks at the frame on the screen. In order to avoid the user from looking at the screen 110 for a long time so as to cause visual injuries, the control unit 140 adjusts the screen 110 to enter an eye protection mode when it determines that the human eyes gaze at the screen 110 over a predetermined time. The eye protection mode comprises an adjustment of brightness, contrast, color or refresh rate of the screen 110 to perform an appropriate setting on the screen 110 for protecting the human eyes.

The abovementioned “predetermined time” can be preset by a programmer or adjusted by the user him/herself, and persons having ordinary skill in the art should choose flexibly depending on the needs at that time For example, the predetermined time can be set to 30s.

On the other hand, if the control unit 140 determines that the human eyes do not gaze the screen 110, it represents that the user does not look at the frame on the screen 110. Thus, the control unit 140 does not need to adjust the brightness, the contrast, the color and the refresh rate of the screen 110. Or, the control unit 140 also can dim the frame of the screen 110 or close the screen 110 for saving power.

When the brightness of the screen 110 is higher than the ambient light, the abovementioned eye protection mode is to adjust the brightness of the screen 110 to be the same with the ambient light and to adjust an appropriate refresh rate, color and contrast of the screen for avoiding the human eyes from injuries.

The contrast is a ratio of black to white in the frame, that is, a gradation from black to white. The larger contrast is, the more gradation from black to white is. Thus, the color performance is abundant. The influence of the contrast for the visual effect is very important. Normally, the larger contrast is, the clearer and more vibrant image is, and the brighter and more beautiful color is. Comparatively, a visual, load of the human eyes is higher. Thus, in an embodiment, the abovementioned eye protection mode is to reduce the contrast of the screen 110 for reducing the visual load. In particular, the contrast cannot be too low for avoiding the frame on the screen 110 from indistinctness.

As to the color, in an embodiment, the abovementioned eye protection mode is to increase a display proportion of a green light source in the screen 110 so as to allow the screen 110 to present a background color having a color slightly shifting towards green. When the user looks at the green color, the injuries received by the macula of retina can be relaxed to allow the human eyes to rest. On the other hand, for color physiology, the green color will provide a feeling of harmonious, relaxer, peace, calm, sincere, satisfied, generous and recovery so that looking at the green color can make human happy.

Normally, the refresh rate of the screen 110 is ranged from 60 Hz to 75 Hz. In an embodiment, the abovementioned eye protection mode is to reduce the refresh rate of the screen 110, such as lower than 60 Hz but higher than 30 Hz, for reducing the injuries of the eyes.

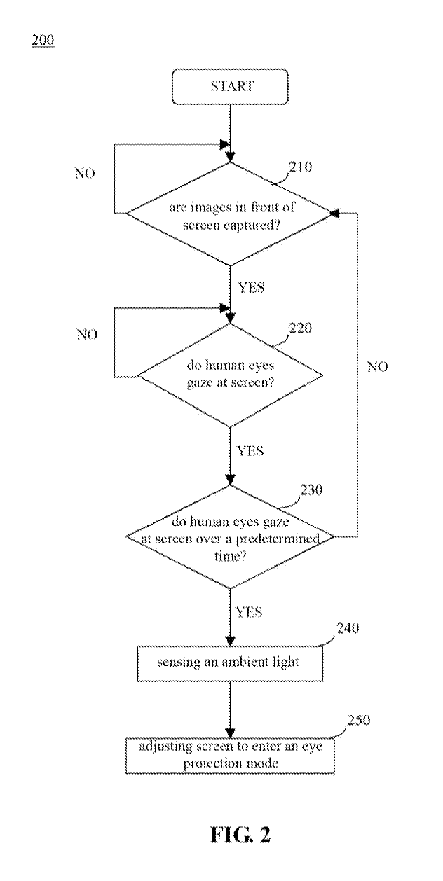

FIG. 2 is a flowchart showing a control method 200 for a screen of an electronic device according to another embodiment of the present invention. As shown in FIG. 2, the control method 200 comprises steps 210-250 (It would be recognized that the order of the steps mentioned in the present embodiment, except for the order described specifically, can be adjusted according to the practical needs and a or partial of them can be performed simultaneously). The hardware, which is utilized to perform the above steps, has been disclosed in the above embodiment, and therefore, there is no need to describe it repeatedly.

In the method 200, images in front of the screen are captured first. And then, it determines whether the images are captured or not in step 210. If yes, it determines whether human eyes gaze the screen in the images in step 220. If yes, it determines whether the human eyes gaze the screen over a predetermined time in step 230. If yes, step 240 is to sense an ambient light. And then, it adjusts the screen to enter an eye protection mode according to the ambient light in step 250 in which the eye protection mode is to adjust brightness, contrast, color or refresh rate of the screen to perform an appropriate setting on the screen 110 for protecting the human eyes

In the step 250, when the brightness of the screen 110 is higher than the ambient light, the abovementioned eye protection mode is to adjust the brightness of the screen 110 to be the same with the ambient light and to adjust an appropriate refresh rate, color and contrast of the screen for avoiding the human eyes from injuries.

In particular, in an embodiment, the contrast of the screen can be reduced in the step 250 to avoid the frame from excessively vibrant and gorgeous for reducing the visual load of the user. In the step 250, the contrast cannot be too low for avoiding the frame on the screen 110 from indistinctness.

On the other hand, the light reflection of the red color is 67%, the yellow color is 65%, the green color is 47% and the black color is 0%. Therefore, the green color is appropriate for the light reflection or the heat absorption of the light and thus adaptable for the nervous system of the human body, cerebral cortex and retina in the eyes. In an embodiment, a display proportion of a green light source in the screen can be increased in the step 250 so as to allow the screen to present a background color having a color slightly shifting towards green. When the user looks at the green color, the injuries received by the macula of retina can be relaxed to allow the human eyes to rest.

Alternately, in an embodiment, the refresh rate of the screen can be reduced in the step 250, such as lower than generally predetermined 60 Hz-76 Hz but higher than 30 Hz, for reducing the injuries of the eyes.

The control method 200 for screen as mentioned above can be performed by a variety of computer devices, such as the abovementioned electronic device 100. A portion of functions also can be implemented as a program product (for example, a mobile application) for downloading by the user. Alternatively, a portion of functions is implemented as an application stored in a computer-readable recording medium to allow the computer to read the recording medium and to execute the control method 200 for screen.

Although the present invention has been described in considerable detail with reference to certain preferred embodiments thereof, the disclosure is not for limiting the scope of the invention. Persons haying ordinary skill in the art may make various modifications and changes without departing, from the scope and spirit of the invention. Therefore, the scope of the appended claims should not be limited to the description of the preferred embodiments described above.

What is claimed is:

1. An electronic device, comprising:
a screen;
an imaging lens provided for capturing images in front of the screen;
a light sensor provided for sensing an ambient light; and
a control unit provided for determining whether human eyes gaze at the screen in the images and adjusting the screen to enter an eye protection mode according to the ambient light when it determines that the human eyes gaze at the screen over a predetermined time, wherein the eye protection mode comprises an adjustment of brightness, contrast, color or refresh rate of the screen.

2. The electronic device according to claim 1, wherein the eye protection mode comprises adjusting the brightness of the screen to be the same with the ambient light when the brightness of the screen is higher than the ambient light.

3. The electronic device according to claim 2, Wherein the eye protection mode comprises reducing the contrast of the screen.

4. The electronic device according to claim 2, wherein the eye protection mode comprises increasing a display proportion of a green light source in the screen.

5. The electronic device according to claim 2, wherein the eye protection mode comprises reducing the refresh rate of the screen.

6. A control method method for a screen of an electronic device, the method comprising:
capturing images in front of the screen;
determining whether human eyes gaze at the screen in the image;
sensing an ambient light when the human eyes is determined to gaze at the screen over a predetermined time; and
adjusting the screen to enter an eye protection mode according to the ambient light, wherein the eye protection mode comprises an adjustment of brightness, contrast, color or refresh rate of the screen.

7. The method according to claim 6, wherein the step of adjusting the screen to enter the eye protection mode comprises:
adjusting the brightness of the screen to be the same with the ambient light when the brightness of the screen is higher than the ambient light.

8. The method according to claim 7, wherein the step of adjusting the screen to enter the eye protection mode further comprises:
reducing the contrast of the screen.

9. The method according to claim 7, wherein the step of adjusting the screen to enter the eye protection mode further comprises:
increasing a display proportion of a green light source in the screen.

10. The method according to claim 7, wherein the step of adjusting the screen to enter the eye protection mode further comprises:
reducing the refresh rate of the screen.
